(19) United States
(12) Patent Application Publication
(10) Pub. No.: US 2021/0142659 A1
(43) Pub. Date: May 13, 2021

(54) METHOD AND SYSTEM FOR MONITORING A ROADWAY SEGMENT

(71) Applicant: GM GLOBAL TECHNOLOGY OPERATIONS LLC, Detroit, MI (US)

(72) Inventors: Shu Chen, Rochester Hills, MI (US); Jinzhu Chen, Troy, MI (US); Mubassira Khan, Austin, TX (US); Mason D. Gemar, Cedar Park, TX (US)

(73) Assignee: GM GLOBAL TECHNOLOGY OPERATIONS LLC, Detroit, MI (US)

(21) Appl. No.: 16/680,973

(22) Filed: Nov. 12, 2019

(51) Int. Cl. G08G 1/01; G08G 1/0967; G08G 1/13

(52) U.S. Cl. CPC G08G 1/0133; G08G 1/0141; G08G 1/13; G08G 1/0129; G08G 1/096708

(57) ABSTRACT

Near-real-time monitoring and analysis of a road segment are described, and include a remotely-located controller that is arranged to wirelessly communicate with a plurality of connected vehicles. This includes periodically capturing vehicle positional data and associated temporal data that are communicated from a subset of the connected vehicles, wherein the subset of the connected vehicles traverse a road segment associated with the digitized roadway map. Vehicle positional data and the associated temporal data are analyzed over a period of time, including evaluating the vehicle positional data in context of the digitized roadway map. Occurrence of an anomalous traffic pattern for the road segment can be detected based upon the evaluating of the vehicle positional data in context of the digitized roadway map and the associated temporal data. A control action is executed based upon detection of the occurrence of the anomalous traffic pattern for the road segment.

### INTRODUCTION

Vehicles, including non-autonomous, semi-autonomous and autonomous vehicles, may make use of mapping information to inform an operator and/or to direct operational control of one or more components of the vehicle. Roadway maps may be generated based on data obtained from survey vehicles that traverse the road network and capture the data, and take time to produce. In addition, portions of such roadway maps may become out-of-date due to road repair events, road construction, and other changes to the road network. Road repair events, accidents, and other short-duration events may cause temporary changes in a portion of a roadway that will not be found on a roadway map, but nonetheless affects traffic patterns at least temporarily.

Accordingly, it is desirable to provide improved methods and systems for near-real time mapping of lane level information on roadway segments to provide timely, up-to-date information to vehicle operators, to enhance operation of navigation systems, and to enhance operation of autonomous vehicle systems. Such information can extend operation of navigation systems and autonomous vehicle systems to roadway segments where such operation may otherwise be disabled as a result of road repair events and/or road construction.

### SUMMARY

A system and associated method for near-real-time monitoring and analysis of a road segment are described, and include a remotely-located controller that is arranged to wirelessly communicate with a plurality of connected vehicles. The controller is in communication with a memory device. The memory device includes a digitized roadway map that is representative of the roadway. The controller includes an instruction set that is executable to periodically capture vehicle positional data and associated temporal data that are communicated from a subset of the connected vehicles, wherein the subset of the connected vehicles traverse a road segment associated with the digitized roadway map. The vehicle positional data includes vehicle speed, geographic position, elevation, and heading for each of the subset of the connected vehicles, and the temporal data includes a time-of-day and a day-of-week for each of the subset of the connected vehicles. The vehicle positional data and the associated temporal data are analyzed over a period of time, including evaluating the vehicle positional data in context of the digitized roadway map. Occurrence of an anomalous traffic pattern for the road segment may be detected based upon the evaluating of the vehicle positional data in context of the digitized roadway map and the associated temporal data. The controller executes a control action based upon detection of the occurrence of the anomalous traffic pattern for the road segment.

An aspect of the disclosure includes the instruction set executable to communicate the occurrence of the anomalous traffic pattern for the road segment by notifying operators of the plurality of connected vehicles that are traversing the road segment of the anomalous traffic pattern.

Another aspect of the disclosure includes the instruction set executable to update the digitized roadway map for the road segment.

Another aspect of the disclosure includes the instruction set executable to update the on-vehicle roadway map for the road segment for each of the plurality of connected vehicles.

Another aspect of the disclosure includes the instruction set executable to deactivate the advanced driver-assistance system.

Another aspect of the disclosure includes the instruction set executable to reroute, via the navigation system, a recommended travel path for the one of the connected vehicles that is traversing the road segment.

Another aspect of the disclosure includes the instruction set executable to detect a lane-specific anomalous traffic pattern based upon the evaluating of the vehicle positional data in context of the digitized roadway map and the associated temporal data.

Another aspect of the disclosure includes the instruction set executable to detect closure of a lane of travel of the road segment based upon the evaluating of the vehicle positional data in context of the digitized roadway map and the associated temporal data.

Another aspect of the disclosure includes the instruction set executable to detect a shift of a lane of travel of the road segment based upon the evaluating of the vehicle positional data in context of the digitized roadway map and the associated temporal data.

Another aspect of the disclosure includes the instruction set executable to detect the occurrence of the anomalous traffic pattern for the road segment in near-real-time.

Another aspect of the disclosure includes the instruction set executable to employ density-based centerline extraction for each lane of the road segment to detect the occurrence of the anomalous traffic pattern for the road segment.

Another aspect of the disclosure includes the instruction including an adaptive segmentation routine to determine a perpendicular distance from a road edge for each of the subset of the connected vehicles based upon the vehicle positional data and associated temporal data.

Another aspect of the disclosure includes the instruction set executable to determine lane-level weighted distributions of traffic density based upon the vehicle positional data and associated temporal data to determine a lane-level anomalous traffic pattern associated with a specific time-of-day and/or a specific day-of-week.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

One or more embodiments will now be described, by way of example, with reference to the accompanying drawings, in which:

FIG. 1 schematically shows a system that includes a remotely-located base server that is arranged to wirelessly communicate with a plurality of connected vehicles, in accordance with the disclosure.

FIG. 2 schematically shows a top view of a road segment that includes multiple lanes of travel and shoulders, in accordance with the disclosure.

FIG. 3 schematically shows a process for evaluating periodically captured vehicle positional data and associated temporal data that are communicated from connected vehicles while traversing a portion of a road segment, in accordance with the disclosure.

FIG. 4 schematically shows a multi-lane road segment associated with a density-based centerline extraction in relation to a reference edge line, in accordance with the disclosure.

FIG. 5 graphically shows data and analysis associated with a multi-lane road segment that is associated with density-based centerline extraction in relation to a reference edge line, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

As used herein, the term “system” may refer to an arrangement of mechanical and electrical hardware, software, firmware, electronic control componentry, processing logic and/or processor device, individually or in combination, including without limitation an application specific integrated circuit (ASIC), an electronic circuit, and/or a processor (shared, dedicated, or group) that executes one or more software or firmware programs, memory to contain software or firmware instructions, a combinational logic circuit, and/or other components that provide the described functionality.

Referring now to the drawings, which are provided for the purpose of illustrating certain exemplary embodiments only and not for the purpose of limiting the same, FIG. 1 schematically illustrates a remotely-located base server 100 that is arranged to wirelessly communicate with a plurality of connected vehicles 20, two of which are illustrated. The base server 100 may be housed in a building and include a controller 10 that includes a processor 12, a first computer-readable storage device or media 13, a second computer-readable storage device or media 14 that includes a digitized base roadway map 15, a navigation system 16, and an executable instruction set 11. The processor 12 includes a telematics system 17 that includes a wireless telecommunication system 18, which may include cellular communication, satellite communication, and/or other communication technologies. As employed herein, the term “roadway map” is a scaled symbolic depiction of roadways of a region in context of geographic features, towns, etc.

Each of the connected vehicles 20 includes a controller 22, a global positioning system (GPS) sensor 26, a telematics device 27, and a navigation system 28. The controller 22 includes a processor 23, a computer-readable storage device or media 24 that may include a digitized on-vehicle roadway map 25 and an executable instruction set 21. One or more of the connected vehicles 20 may include an autonomic vehicle control system 40 that is capable of providing some level of autonomous vehicle operation, including, e.g., an advanced driver-assistance system (ADAS). The connected vehicles 20 may include, by way of non-limiting examples, a four-wheel passenger vehicle with steerable front wheels and fixed rear wheels. The connected vehicles 20 may include, by way of non-limiting examples, a passenger vehicle, a light-duty or heavy-duty truck, a two-wheeled vehicle, e.g., a motorcycle, a three-wheeled vehicle, a utility vehicle, an agricultural vehicle, an industrial/warehouse vehicle, a recreational off-road vehicle, an airplane, or a marine vehicle. In addition to vehicle position information that is provided by the GPS sensor 26, other vehicle position data may include data from on-board sensors such as a CAN bus trace data, camera data, lidar data, and/or radar data.

The autonomic vehicle control system 40 includes an on-vehicle control system that is capable of providing a level of driving automation. The terms ‘driver’ and ‘operator’ describe the person responsible for directing operation of the connected vehicle 20, whether actively involved in controlling one or more vehicle functions or directing autonomous vehicle operation. Driving automation can include a range of dynamic driving and vehicle operation. Driving automation can include some level of automatic control or intervention related to a single vehicle function, such as steering, acceleration, and/or braking, with the driver continuously having overall control of the connected vehicle 20. Driving automation can include some level of automatic control or intervention related to simultaneous control of multiple vehicle functions, such as steering, acceleration, and/or braking, with the driver continuously having overall control of the connected vehicle 20. Driving automation can include simultaneous automatic control of vehicle driving functions, including steering, acceleration, and braking, wherein the driver cedes control of the connected vehicle 20 for a period of time during a trip. Driving automation can include simultaneous automatic control of vehicle driving functions, including steering, acceleration, and braking, wherein the driver cedes control of the connected vehicle 20 for an entire trip. Driving automation includes hardware and controllers configured to monitor the spatial environment under various driving modes to perform various driving tasks during dynamic operation. Driving automation can include, by way of non-limiting examples: cruise control; adaptive cruise control; lane-change warning, intervention and control; automatic parking; acceleration; braking; etc.

The telematics device 27 is configured to wirelessly communicate information to and from other entities, either directly, or via the telecommunication system 50. Other entities may include, but are not limited to, other connected vehicles, infrastructure, networks, pedestrians, remote transportation systems, and/or user devices, referred to as vehicle-to-everything, or V2X communication. In an exemplary embodiment, the telematics device 27 includes a wireless communication system configured to communicate via a wireless local area network (WLAN) using IEEE 802.11 standards or by using cellular data communication. However, additional or alternative communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The telecommunication system 50 may include cellular communication, satellite communication, and/or other communication technologies that are arranged to effect wireless communication between the connected vehicles 20 and the base server 100.

The term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event.

Communication includes exchanging data signals in suitable form, including, for example, electrical signals via a conductive medium, an electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

Referring now to FIGS. 2 and 3 and with continued reference to the connected vehicles 20 and the remotely-located base server 100 of FIG. 1, a process 300 is described for evaluating periodically captured vehicle positional data and associated temporal data that are communicated from a plurality of the connected vehicles 20 while traversing, in near-real-time, a portion of a road segment 200 that is identified on the on-vehicle roadway map 25 and/or the base roadway map 15. As used herein, the term “near-real-time” represents a period of time associated with capturing a statistically significant amount of vehicle positional data and associated temporal data from a plurality of the connected vehicles 20 while traversing the road segment 200 to identify lane-specific traffic patterns for the road segment 200.

The process 300 can include detection of occurrence of a lane-specific anomalous traffic pattern for the road segment 200 based upon near-real-time evaluation of positional data from the plurality of the connected vehicles 20 in context of the on-vehicle roadway map 25 and the associated temporal data. The detection of occurrence of a lane-specific anomalous traffic pattern for the road segment 200 is communicated to controllers 22 of all or selected ones the connected vehicles 20 that traverse the road segment 200. The controller 22 executes a control action based upon the detection of occurrence of the lane-specific anomalous traffic pattern for the road segment 200 when the connected vehicle 20 is traversing the road segment 200. The control action may include communicating the occurrence of the anomalous traffic pattern for the road segment 200, including notifying the vehicle operator of the connected vehicle 20 of the lane-specific anomalous traffic pattern; commanding deactivation of the ADAS 40 when employed on the specific connected vehicle 20; recommending and/or commanding the vehicle operator of the connected vehicle 20 to execute a lane change; rerouting, via the navigation system 28, the specific connected vehicle 20 to another travel path in place of traversing the road segment 200; and/or recommending, via the navigation system 28, another travel path to the operator of the specific connected vehicle 20 when approaching the road segment 200. The control action may also include updating the base roadway map 15 and/or the on-vehicle roadway map 25 as related to the road segment 200.

FIG. 2 schematically shows a top view of the road segment 200 that includes three lanes L1, L2, L3, respectively, and leftward and rightward shoulders LB, RB, respectively. The road segment 200 is included as a portion of the base roadway map 15 and/or the on-vehicle roadway map 25. The three lanes L1, L2, L3 are travel lanes that are traversed by vehicles, including a subset of the connected vehicles 20 that are described with reference to FIG. 1. A portion of the road segment 200 includes a construction event 210 that occludes vehicle passage on the leftward shoulder LB and lane L1, causing an anomalous traffic pattern in the form of a rightward shift in the travel lanes to include lanes L2, L3 and the rightward shoulder RB for at least a portion of the road segment 200, and an associated leftward shift in the travel lanes to the original travel lanes beyond the construction event 210. As appreciated, the construction event 210 may not be incorporated into the digitized vehicle roadway map 25 of any one of the connected vehicles 20, and also may not be incorporated into the digitized system roadway map 15 of the remotely-located base server 100 due to its temporary, short-term occurrence. However, vehicle travel paths and traffic conditions associated with the road segment 200 may be affected as a result of the anomalous traffic pattern caused by the construction event 210. Such traffic conditions associated with the road segment 200 resulting from the event may be short-term in nature, but may affect vehicle navigation and control at least temporarily. Furthermore, traffic conditions may be temporal, such as being specific to a time-of-day and/or a day-of-week due to traffic loads such as congestion and flow.

Execution of the process 300 may proceed as follows. The steps of the process 300 may be executed in a suitable order, and are not limited to the order described with reference to FIG. 3. As employed herein, the term “1” indicates an answer in the affirmative, or “YES”, and the term “0” indicates an answer in the negative, or “NO”. The teachings may be described herein in terms of functional and/or logical block components and/or various processing steps. It should be realized that such block components may be composed of hardware, software, and/or firmware components that have been configured to perform the specified functions. The block components may represent computer instructions that, when executed by one or more processors, perform the recited operations.

The process 300 includes periodically capturing vehicle positional data and associated temporal data that are communicated from embodiments of the connected vehicles 20 as the connected vehicle 20 traverses one of the lanes in a road segment (302), e.g., road segment 200 that is shown with reference to FIG. 2. This includes identifying the associated road segment in the digitized roadway map, i.e., either or both the on-vehicle roadway map 25 and the base roadway map 15 (304). The vehicle positional data and associated temporal data are captured by the controller 10 at the remotely-located base server 100 at a data capture rate of every 2-5 seconds, thus permitting data clustering to identify travel paths of the connected vehicles 20 on the road segment. Examples of vehicle positional data include vehicle speed, geographic position, elevation, and heading for each of the connected vehicles 20, and the associated temporal data includes a time-of-day and a day-of-week for each of the subset of the connected vehicles 20. After filtering out extraneous data points (306), historical data that has been captured from a plurality of the connected vehicles 20 that have traversed the road segment is positionally aligned with the road segment via a map matching routine and an adaptive segmentation routine (308).

The adaptive segmentation routine includes a method to calculate a perpendicular distance of a vehicle, e.g., one of the connected vehicles 20, from a reference line, such as a road edge. An example of a road edge is shown with reference to FIG. 4 in the form of a reference edge line 410. The perpendicular distance of one of the connected vehicles 20 from a reference line may be determined using information related to the vehicle heading, wherein the perpendicular distance is determined as a linear measurement or estimation of a length of a vector that projects orthogonal to a line that is defined by the vehicle heading, wherein the vector terminates at the reference line.

The historical data includes vehicle positional data and associated temporal data for each of the connected vehicles 20, wherein the vehicle positional data includes vehicle speed, geographic position, elevation, and heading, and wherein the temporal data includes a time-of-day and a day-of-week.

After data preprocessing steps are performed (310), historical performance metrics are compiled for normal conditions related to lane-specific travel paths employing the historical data (312). The compiled historical performance metrics include a perpendicular offset from a baseline, an associated travel speed, traffic volume (vehicles per hour) that have been parsed by segmenting the temporal data into categories of a time-of-day and a day-of-week for the lane-specific travel paths. The historical performance metrics that are determined for expected normal conditions employing the historical data are employed to train a machine learning model, e.g., a neural network (314), which is employed to evaluate temporal performance metrics. The machine learning model develops a classifier that has been trained to detect occurrence of anomalous traffic patterns based upon compilation of data that is associated with the subject road segment that includes vehicle perpendicular offsets for each travel lane from a nominal map alignment line, traffic volume, vehicle speeds, and events. Each day, performance metrics for the subject road segment are estimated for time-of-day and day-of-week based upon the vehicle positional data and associated temporal data that are communicated from embodiments of the connected vehicles 20 and compiled for that day and subjected to analysis (316).

The daily performance metrics are evaluated by comparison with the historical performance metrics (318), with analysis of the vehicle positional data and associated temporal data to detect a lateral shift in the vehicle positional data, a change in an average speed of the traffic flow, or a change in traffic volume (vehicles per hour) through the road segment. The lateral shift in the vehicle positional data, the reduction in speed of the traffic flow or the reduction in traffic volume may indicate occurrence of an anomalous traffic pattern such as a lane shift or a lane closure in the road segment. A lane closure event may be indicated by occurrence of anomalous traffic behavior that is consistent across a time-of-day aggregation and a day-of-week aggregation. An intermittent event or a shoulder closure event may be indicated by a time-dependent occurrence of anomalous traffic behavior.

This road segment-level of analysis is evaluated to determine whether construction activity or another short-term road segment event has caused a change in the lateral shift that indicates occurrence of an anomalous traffic pattern in at least one of the travel lanes (320). When the road segment-level of analysis evaluation indicates absence of an anomalous traffic pattern (320)(0), the process 300 indicates that the subject road segment is normal and this iteration ends (321).

When the road segment-level of analysis evaluation indicates occurrence of an anomalous traffic pattern (320)(1), a lane-level analysis is undertaken, which includes performing a density-based centerline extraction for each of the lanes of the subject road segment (322) and an associated geographic coordinate projection (324).

The near-real-time analysis can be conducted to determine specific performance metrics, including e.g., vehicle volume, speed, and position, that are related to vehicle operational characteristics, at the road and lane-level, and identify roadway alignment and/or volume changes associated with construction activity or another lane-specific anomalous traffic pattern that may be caused by a traffic accident, a stalled vehicle, or roadway debris that are present in one of the lanes of travel. FIGS. 4 and 5 schematically illustrate aspects of near-real-time data analysis that are associated with density-based centerline extraction for each of the lanes of a multi-lane road segment 400.

Referring again to FIG. 3, the geographic coordinate projection for the density-based centerline extraction for each of the travel lanes of the subject road segment is subjected to classification and labelling to identify individual travel lanes and indicate which of the lanes of the subject road segment are opened or closed to travel (326). This is subjected to a normalization step (328), and lane-level weighted distributions of traffic density are estimated in the context of the temporal data of time-of-day and day-of-week (330). In one embodiment, estimating the lane-level weighted distributions of traffic density in the context of the temporal data of time-of-day and day-of-week (330) includes normalizing the weight for each of the travel lanes (Lane i) based on the number of points (NoP) and the number of vehicles (NoV) distribution to remove a daily variance effect, in accordance with the following equation:

$$N {W}_{Lane i} = \frac{{W}_{1} \frac{N o {V}_{Lane i}}{T N o V} + {W}_{2} \frac{N o {P}_{Lane i}}{T N o P}}{{W}_{1} + {W}_{2}} ( {\sum }_{i = 1}^{n} {W}_{i} = 1 ) \qquad [ 1 ]$$

wherein:
NW_{Lane i} represents the normalized weight associated with Lane i;
TNoV represents a total quantity of vehicles over a time period; and
TNoP represents a total quantity of points over the time period.

This result is compared to thresholds associated with temporal-based normal activity for the respective lane of the subject road segment (332) to verify presence or absence of a lane-level anomalous traffic pattern (334), including an indication whether the lane-level anomalous traffic pattern is associated with a specific time-of-day and/or a specific day-of-week.

When the comparison verifies an absence of a lane-specific anomalous traffic pattern activity (334)(0), the process 300 indicates that the subject road segment is normal for the specific time-of-day and/or the specific day-of-week and this iteration ends (321).

When the comparison verifies an occurrence of an anomalous traffic pattern which may indicate a presence of lane-level construction activity (334)(1), the process 300 labels the subject road segment as being in an anomalous traffic pattern condition for the specific time-of-day and/or the specific day-of-week, with lane-level activity being characterized based upon the foregoing analysis (336). This result of occurrence of a lane-specific anomalous traffic pattern may be associated with the subject road segment and captured in the base roadway map 15 that is accessible by the controller 10 of the remotely-located base server 100 and in the vehicle roadway map 25 that is stored on-vehicle and accessible to the controller 22 of the connected vehicle 20.

Referring again to FIGS. 4 and 5, the multi-lane road segment 400 is shown, including a reference edge line 410. A plurality of data points 420 are shown, representing GPS data points from multiple connected vehicles that have recently traversed the multi-lane road segment 400. Perpendicular distances from the reference edge line 410 are determined for the plurality of data points 420 and subjected to a density function analysis, as shown graphically with reference to element 415 in FIG. 5. The density function analysis 415 graphically shows a probability density 404 on the vertical axis in relation to perpendicular distance 402 from the reference edge line 410 on the horizontal axis, with the reference edge line 410 so indicated. A plurality of maximum densities 411, 412, 413, emerge from the density function analysis 415 and represent maximum densities associated with perpendicular distances of the plurality of data points 420 from the reference edge line 410. The plurality of maximum densities 411, 412, 413 translate to lane centroids, which are illustrated in FIG. 4 as elements 421, 422, 423, respectively, on the multi-lane road segment 400, and indicate travel lanes 1, 2 and 3, respectively. This analysis, which can be conducted in near-real-time employing data from multiple connected vehicles that have recently traversed the multi-lane road segment 400, can be executed to identify the travel lanes traversed by vehicles irrespective of lane markings and other lane conventions, thus indicating occurrence of an anomalous traffic pattern such as a lane shift or a lane closure in the road segment.

Furthermore, the near-real-time analysis can be conducted to determine specific performance metrics (e.g., vehicle volume, speed, and position) related to vehicle operational characteristics, at the road segment level and the lane-specific level, and identify an anomalous traffic pattern affecting roadway alignment and/or volume changes associated with construction activity or another anomalous traffic pattern that may be caused by a traffic accident, a stalled vehicle, or roadway debris that are present in one of the lanes of travel. Furthermore, the near-real-time analysis can be conducted using vehicle telemetry data in near real time to calculate specific performance metrics (e.g., vehicle volume, speed, and position) related to vehicle operational characteristics, at the road and lane-level, and identify roadway alignment and/or volume changes inherent to construction activity. Telemetry data are analyzed to describe construction activity characteristics, including spatial (distance along roadway, lanes impacted, map segments impacted) and temporal (dates, days of week, and times of day impacted) limits. This process can be automated and scaled to cover map segments across any roadway network where connected vehicles operate.

Portions of the remotely-located base server 100 described herein may be implemented in cloud computing environments. The term “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The remotely-located base server 100 includes a processing device, a communication device, and memory device that preferably includes a file including a store inventory. The processing device of the remotely-located base server 100 can include memory, e.g., read only memory (ROM) and random access memory (RAM), storing processor-executable instructions and one or more processors that execute the processor-executable instructions. In embodiments including two or more processors, the processors can operate in a parallel or distributed manner.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A system, comprising:
a controller, arranged to wirelessly communicate with a plurality of connected vehicles, and in communication with a memory device;
the memory device, including a digitized roadway map;
the controller including an instruction set, the instruction set executable to:
periodically capture vehicle positional data and associated temporal data that are communicated from a subset of the connected vehicles, wherein the subset of the connected vehicles are traversing a road segment associated with the digitized roadway map, wherein the vehicle positional data includes vehicle speed, geographic position, elevation, and heading for each of the subset of the connected vehicles, and wherein the associated temporal data includes a time-of-day and a day-of-week for each of the subset of the connected vehicles;
analyze the vehicle positional data and the associated temporal data over a period of time, including evaluating the vehicle positional data in context of the digitized roadway map;
detect occurrence of an anomalous traffic pattern for the road segment based upon the evaluating of the vehicle positional data in context of the digitized roadway map, and the associated temporal data; and
execute a control action based upon the occurrence of the anomalous traffic pattern for the road segment.

2. The system of claim 1, wherein the instruction set executable to execute the control action based upon the occurrence of the anomalous traffic pattern for the road segment comprises the instruction set executable to communicate the occurrence of the anomalous traffic pattern for the road segment by notifying operators of the plurality of connected vehicles that are traversing the road segment of the anomalous traffic pattern.

3. The system of claim 1, wherein the instruction set executable to execute the control action based upon the occurrence of the anomalous traffic pattern for the road segment comprises the instruction set executable to update the digitized roadway map for the road segment.

4. The system of claim 1, wherein the instruction set executable to execute the control action based upon the occurrence of the anomalous traffic pattern for the road segment comprises the instruction set executable to update the digitized roadway map for the road segment for each of the plurality of connected vehicles.

5. The system of claim 1, wherein one of the connected vehicles includes an advanced driver-assistance system, and wherein the instruction set executable to execute the control action based upon the occurrence of the anomalous traffic pattern for the road segment comprises the instruction set executable to deactivate the advanced driver-assistance system.

6. The system of claim 1, wherein one of the connected vehicles traversing the road segment includes a navigation system, and wherein the instruction set executable to execute the control action based upon the occurrence of the anomalous traffic pattern for the road segment comprises the instruction set executable to reroute, via the navigation system, a recommended travel path for the one of the connected vehicles that is traversing the road segment.

7. The system of claim 1, wherein the instruction set executable to detect the occurrence of the anomalous traffic pattern for the road segment comprises the instruction set executable to detect a lane-specific anomalous traffic pattern based upon the evaluating of the vehicle positional data in context of the digitized roadway map and the associated temporal data.

8. The system of claim 7, wherein the instruction set executable to detect the occurrence of the lane-specific anomalous traffic pattern for the road segment comprises the instruction set executable to detect closure of one or multiple lanes of travel of the road segment based upon the evaluating of the vehicle positional data in context of the digitized roadway map and the associated temporal data.

9. The system of claim 7, wherein the instruction set executable to detect occurrence of the lane-specific anomalous traffic pattern for the road segment comprises the instruction set executable to detect a shift of a lane of travel of the road segment based upon the evaluating of the vehicle positional data in context of the digitized roadway map and the associated temporal data.

10. The system of claim 1, wherein the instruction set is executable to detect the occurrence of the anomalous traffic pattern for the road segment in near-real-time.

11. The system of claim 1, further comprising the instruction set executable to employ density-based centerline extraction for each lane of the road segment to detect the occurrence of the anomalous traffic pattern for the road segment.

12. The system of claim 1, wherein the instruction set executable to analyze the vehicle positional data and the associated temporal data over the period of time comprises the instruction set including an adaptive segmentation routine to determine a perpendicular distance from a road edge for each of the subset of the connected vehicles based upon the vehicle positional data and the associated temporal data.

13. The system of claim 1, wherein the instruction set executable to analyze the vehicle positional data and the associated temporal data over the period of time comprises the instruction set executable to determine lane-level weighted distributions of traffic density based upon the vehicle positional data and the associated temporal data to determine a lane-level anomalous traffic pattern associated with a specific time-of-day or a specific day-of-week.

14. A method for monitoring a road segment, comprising:
periodically capturing vehicle positional data and associated temporal data associated with a subset of connected vehicles, wherein the subset of the connected vehicles is traversing the road segment, wherein the road segment is associated with a digitized roadway map,
analyzing the vehicle positional data and the associated temporal data over a period of time;
evaluating the vehicle positional data in context of the digitized roadway map;
detecting occurrence of an anomalous traffic pattern for the road segment based upon the evaluating of the vehicle positional data in context of the digitized roadway map, and the associated temporal data; and
executing, via a controller, a control action based upon the occurrence of the anomalous traffic pattern for the road.

15. The method of claim 14, wherein the vehicle positional data includes vehicle speed, geographic position, elevation, and heading for each of the subset of the connected vehicles, and wherein the temporal data includes a time-of-day and a day-of-week for each of the subset of the connected vehicles.

16. The method of claim 14, wherein executing the control action based upon the occurrence of the anomalous traffic pattern for the road segment comprises updating the digitized roadway map for the road segment for each of the connected vehicles.

17. The method of claim 14, wherein one of the connected vehicles includes an advanced driver-assistance system, and wherein executing the control action based upon the occurrence of the anomalous traffic pattern for the road segment comprises deactivating the advanced driver-assistance system.

18. The method of claim 14, wherein one of the connected vehicles traversing the road segment includes a navigation system, and wherein executing the control action based upon the occurrence of the anomalous traffic pattern for the road segment comprises rerouting, via the navigation system, a recommended travel path for the one of the connected vehicles that is traversing the road segment.

19. The method of claim 14, wherein detecting occurrence of the anomalous traffic pattern for the road segment comprises detecting a lane-specific anomalous traffic pattern based upon the evaluating of the vehicle positional data in context of the digitized roadway map and the associated temporal data.

20. The method of claim 14, wherein analyzing the vehicle positional data and the associated temporal data over a period of time comprises executing an adaptive segmentation routine to determine a perpendicular distance from a road edge for each of the subset of the connected vehicles based upon the vehicle positional data and the associated temporal data.
